(19) United States
(12) Patent Application Publication
(10) Pub. No.: US 2021/0223668 A1
(43) Pub. Date: Jul. 22, 2021

(54) ORBITING CAMERA MOUNT WITH INTEGRATED ELECTRONIC CAMERA POSITIONING AND FUNCTIONAL CONTROL

(71) Applicant: Vue Events, Inc., Arlington, VA (US)

(72) Inventor: William L. WILEY, JR., Arlington, VA (US)

(73) Assignee: Vue Events, Inc., Arlington, VA (US)

(21) Appl. No.: 17/150,072

(22) Filed: Jan. 15, 2021

Related U.S. Application Data
(60) Provisional application No. 62/962,326, filed on Jan. 17, 2020.

(51) Int. Cl. G03B 17/56; F16M 11/12; F16M 11/20

(52) U.S. Cl. CPC G03B 17/561; F16M 11/2092; F16M 11/2014; F16M 11/126

(57) ABSTRACT

An apparatus for operating an imaging device. The apparatus can include a platform assembly supporting the apparatus on a surface and extending in a first plane, a first arm rotatable about an axis of rotation orthogonal to the first plane, with the axis of rotation being disposed at the platform assembly. The apparatus can further include a second arm coupled to the first arm and extending in a second plane, a carriage slidably coupled to the second arm, with the carriage including a mount couplable to the imaging device, and the mount being tiltable in the second plane. The apparatus can further include at least one electronic system configured to control one or more of a rotation of the first arm, a sliding of the carriage, and a tilting of the mount.

### CROSS-REFERENCE TO RELATED APPLICATIONS

This application claims priority to U.S. Provisional Application 62/932,626, filed Jan. 17, 2020 and entitled “ORBITING CAMERA MOUNT WITH INTEGRATED ELECTRONIC CAMERA POSITIONING AND FUNCTIONAL CONTROL”, the entire contents of which are hereby incorporated by reference.

### BACKGROUND

Conventional methods of filming a stationary person or object by using multiple cameras or imaging devices surrounding the person or object require significant equipment, setup, and planning. This limits the ability to capture this unique effect in a cost-effective and timely manner. As an alternative, a single camera can be attached to an arm that rotates about the object of interest. In this approach, it is desirable to be able to precisely control the acceleration, speed and positioning of the arm, possibly in combination with the ability to control the camera height above the arm, the vertical tilt of the camera, and camera functions such as shutter, recording, focus and zoom. It is also desirable to be able to configure and control these elements as well as receive notifications from them in a wired and/or wireless manner. Such an integration allows videos and photos to be captured in a repeatable, time-efficient manner as either a stand-alone system or as an element within larger applications, such as those used for photo- and videobooths, scientific imaging, or 3D-modeling.

### SUMMARY

According to at least one exemplary embodiment, an apparatus for operating an imaging device is disclosed. The apparatus can include a platform assembly supporting the apparatus on a surface and extending in a first plane, a first arm rotatable about an axis of rotation orthogonal to the first plane, with the axis of rotation being disposed at the platform assembly. The apparatus can further include a second arm coupled to the first arm and extending in a second plane, a carriage slidably coupled to the second arm, with the carriage including a mount couplable to the imaging device, and the mount being tiltable in the second plane. The apparatus can further include at least one electronic system configured to control one or more of a rotation of the first arm, a sliding of the carriage, and a tilting of the mount.

According to a further exemplary embodiment, a system for supporting and operating an imaging device and having a plurality of subsystems is disclosed. The system can include an arm rotation subsystem configured to electronically control an orbiting of the imaging device about an axis of rotation, a height position subsystem configured to electronically control a height of the imaging device in a plane containing the imaging device and the axis of rotation, and a tilt position subsystem configured to electronically control a tilting of the imaging device about a tilting axis orthogonal to the plane containing the imaging device and the axis of rotation. In operation, the imaging device is maintained in orientation so as to capture a portion of the axis of rotation, irrespective of the orbiting, height, and tilt of the imaging device.

### BRIEF DESCRIPTION OF THE FIGURES

Advantages of embodiments of the present invention will be apparent from the following detailed description of the exemplary embodiments. The following detailed description should be considered in conjunction with the accompanying figures in which:

FIG. 1a shows an exemplary embodiment of an orbiting camera mount with a camera.

FIG. 1b shows an enlarged portion of the orbiting camera mount, with a mobile device.

FIG. 2 shows an exemplary embodiment of a control system for controlling an orbiting camera mount.

FIG. 3 shows another exemplary embodiment of an orbiting camera mount.

### DETAILED DESCRIPTION

Aspects of the invention are disclosed in the following description and related drawings directed to specific embodiments of the invention. Those skilled in the art will recognize that alternate embodiments may be devised without departing from the spirit or the scope of the claims. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

Further, many of the embodiments described herein may be described in terms of sequences of actions to be performed by, for example, elements of a computing device. It should be recognized by those skilled in the art that the various sequence of actions described herein can be performed by specific circuits (e.g., application specific integrated circuits (ASICs)) and/or by program instructions executed by at least one processor. Additionally, the sequence of actions described herein can be embodied entirely within any form of computer-readable storage medium such that execution of the sequence of actions enables the processor to perform the functionality described herein. Thus, the various aspects of the present invention may be embodied in a number of different forms, all of which have been contemplated to be within the scope of the claimed subject matter. In addition, for each of the embodiments described herein, the corresponding form of any such embodiments may be described herein as, for example, “a computer configured to” perform the described action. As used herein, the terms “image capture device” and “camera” may be used interchangeably to describe any device that is capable of capturing and recording still or moving images, and are not limited to any particular implementation or form factor for providing such functionality.

According to at least one exemplary embodiment, an orbiting camera mount having a camera support structure orbiting an animate or inanimate object to be filmed is disclosed. The mount can include a rotatable arm oriented substantially horizontally coupled to a pivoting arm oriented substantially vertically or diagonally. A movable carriage is mounted on the pivoting arm and a tiltable mount for an imaging device is provided on the movable carriage. Motorized drives are provided for the rotatable arm and the movable carriage. The functionality and movement of the rotatable arm, movable carriage, tiltable mount, and imaging device may be electronically controlled, integrated, and controlled by a computer program product on a computing device or the imaging device.

According to another exemplary embodiment, a system for controlling an orbiting camera mount is disclosed. The system can be adapted to control the aspects and functionalities of various subsystems which include controllers that operate and control the components of the orbiting camera mount and of the image capture device. Image capture device functionalities can include, for example, shutter, recording, focus, zoom, and so forth. The system can further receive signals and notifications from the subsystems, and can send signals and notifications to the subsystems so as to control the such. The system may control the subsystems of the orbiting camera mount based on user input, based on input from the various subsystems, and/or based on a programmed routine which may include a sequence of one or more steps to be performed by one or more of the various subsystems. The programmed routines may likewise utilize signals and notifications from the various subsystems and may include conditional operations based thereon. The communications between the system and/or subsystems may be accomplished using wired or wireless means, such that all movement and control is executed in a coordinated manner. Additionally, the system may receive switch and sensor notifications such as those from a wireless key fob, wired switch, an accelerometer (which may be external or embedded in a camera) as well as those resulting from motion or gestures detected and processed by the imaging device.

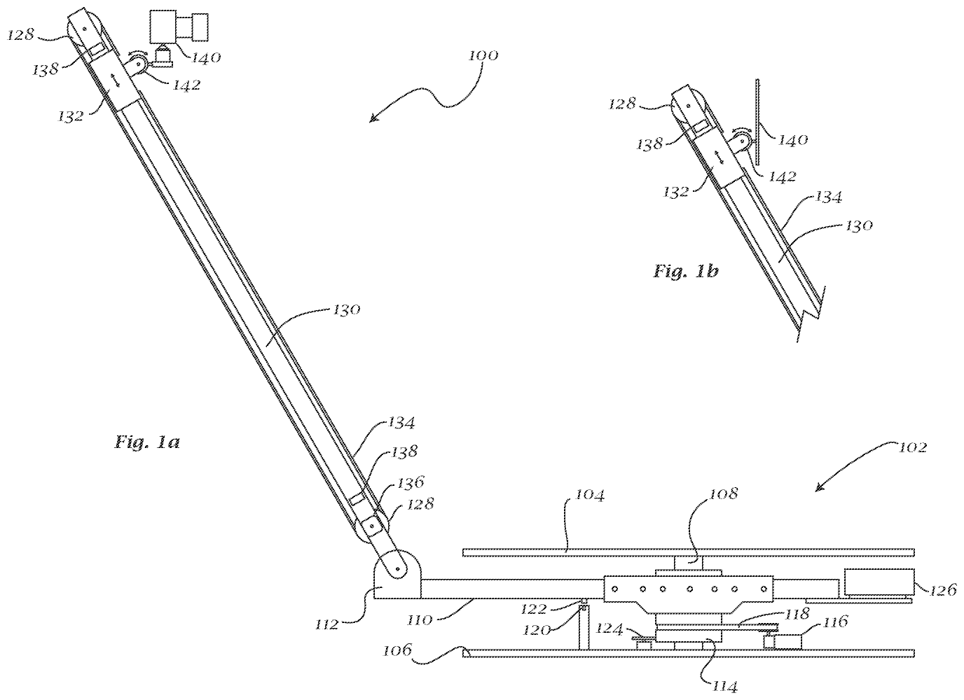

According to another exemplary embodiment, and as shown in FIG. 1, an orbiting camera mount 100 is disclosed. The orbiting camera mount can include a platform assembly 102 having an upper plate 104 and a lower plate 106 connected by a central shaft 108. A rotatable arm 110 may be rotatably coupled to central shaft 108, so as to rotate about shaft 108, and may have a first end 112 extending beyond the outer edge of upper plate 106. The rotatable coupling between arm 110 and shaft 108 may be provided by a housing 114 fixedly coupled to arm 110 and rotatably receiving shaft 108 within a bore defined through housing 114. A subject to be filmed may be positioned on upper plate 104 and arm 110 may rotate around the subject.

A motor 116 may be provided to drive the rotation of arm 110. The motor may be mounted on lower plate 106 and can drive the rotation by a belt 118 extending between the motor and housing 114. The rotation and precise positioning of arm 110 may be controlled by a variety of devices. In one exemplary embodiment, a hall effect sensor 120, a magnet 122 and a rotational encoder 124 may be provided to control the positioning and rotation of arm 110. In some exemplary embodiments, the drive of the rotation of arm 110 may be provided by other mechanisms, such as, for example a gear train between motor 116 and arm 110. Other mechanisms for driving and precisely positioning arm 110 that enable mount 100 to function as described herein may be contemplated and provided as desired.

Pivotably coupled to rotatable arm 110 may be a pivoting arm 130. Pivoting arm 130 can extend in a substantially vertical or diagonal direction away from the pivotable coupling to arm 110. At an end of rotatable arm 110 opposite first end 112, a counterweight 126 to pivoting arm 130 and associated structures may be provided. In some exemplary embodiments, counterweight 126 may be, for example, a battery provided for powering the various components of mount 100. In other exemplary embodiments, power may be provided by an external power source.

A carriage 132 may be slidably disposed on pivoting arm 130, and may be coupled to a belt 134. Belt 134 may be mounted on a pair of sheaves 128 disposed at opposite ends of pivotable arm 130. A motor 136, for example a stepper motor, may drive one of the sheaves so as to move belt 134 and carriage 132. A pair of limit sensors 138 may be provided at opposite ends of pivotable arm 130 so as to determine the limit positions of carriage 132. In some embodiments, other mechanisms for moving carriage 132 that enable mount 100 to function as described herein may be contemplated and provided as desired.

Carriage 132 may be provided with a tilting mount 142 for an image capture device 140. Image capture device 140 may be a photo camera, video camera, smart phone, tablet, or any other image capture device known in the art that is capable of recording photographs or video and that enables mount 100 to function as described herein. In some exemplary embodiments, image capture device 140 may be communicatively coupled to at least one of mount 100 and a computing device.

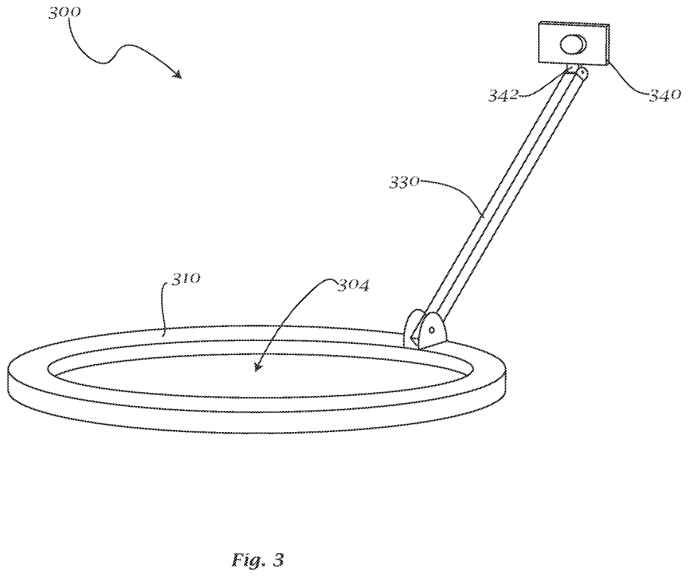

In another exemplary embodiment, as shown only schematically in FIG. 3, an orbiting camera mount 300 may not include a platform structure. A circular track 310 may be provided, and a subject to filmed may be placed in an image capture area 304 within the circular track 310. An orbiting arm 330 may be slidably or movably coupled to the circular track 310, such that the arm orbits around the subject. A tilting mount 342 couplable to an image capture device 340 may be mounted on arm 330. Mechanisms for tilting and sliding the camera mount may be provided substantially similarly to camera mount 100, or in any manner that enables mount 300 to function as described herein. Similarly, mechanisms for moving arm 330 along circular track 310, including but not limited to, wheels, bearings, rails, motors, and so forth, that enable mount 300 to function as described herein may be contemplated and provided as desired.

In some exemplary embodiments, orbiting camera mount 100 may be provided with subsystems for the control of the various aspects and functionalities thereof. The various subsystems may also be communicatively coupled to each other, as well as to the image capture device and a computing device. The various subsystems may provide notifications via these communicative couplings.

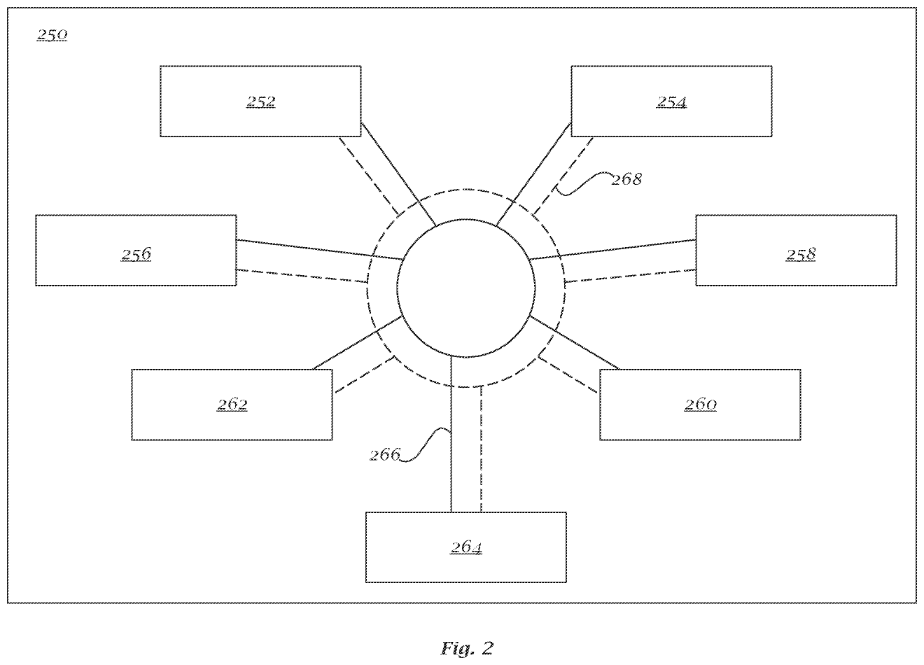

Turning to FIG. 2, a control system 250 for controlling an orbiting camera mount is disclosed. Control system 250 can include one or more of an Arm Rotation Subsystem 252, a Height Subsystem 254, a Tilt Subsystem 256, a Camera Control Subsystem 258, a Trigger/Notification Subsystem 260, a User Interface Subsystem 262, and a Supervisory Subsystem 264. The various subsystems of control system 250 may be communicatively coupled via one or more wired connections 266, one or more wireless connections 268, or a combination thereof.

In some exemplary embodiments, when in operation, the control system can operate the orbiting camera mount so as to maintain the object being filmed within the field of view of the camera, throughout all positions of the orbiting, height, and tilt of the camera.

The Arm Rotation Subsystem 252 may be adapted for driving the arm, maintaining velocity, and reporting the position of the arm. The Arm Rotation Subsystem may communicatively couple to an image capture device via known wired or wireless interfaces. In some exemplary embodiments, the Arm Rotation Subsystem may control the positioning of the arm 110 via motor 116, sensor 120, magnet 122, and encoder 124. A variety of motor types, sensors and control circuitry can be used to drive the arm, maintain velocity, and report the position thereof. In one embodiment, a brushed or brushless motor can be used in conjunction with an external rotational encoder, pulse-width-modulation motor control circuit, and a programmed controller to create a closed-loop system that responds to external signals such as start/stop, desired position and velocity. In alternative embodiments, the same functions can be achieved by using a brushed or brushless motor with an integrated encoder or by a stepper motor using a motor control circuit.

Such embodiments may optionally employ a mechanism to identify fixed positions around the rotational axis relative to the physical chassis. Possible devices for providing this function include mechanical switches, optical, hall-effect, and/or ultrasonic sensors as well as sensors embedded with an encoder or motor. According to various exemplary embodiments, one or more of these devices may be used in place of the encoder.

As a non-limiting example, the functions that the Arm Rotation Subsystem may provide can include:
Initializing the arm position by determining its position relative to chassis;
Rotating the arm to a designated angular position relative to the chassis;
Saving an angular position of the arm as a start or stop position;
Accelerating or decelerating the arm in a controlled or uncontrolled manner;
Rotating the arm in a specific direction;
Rotating the arm at a specific velocity;
Rotating the arm at a specific power level;
Rotating the arm for a specific duration;
Rotating the arm for a specific number of degrees;
Rotating the arm for a specific duration after reaching a stable or designated velocity;
Rotating the arm for a specific number of degrees after reaching a stable or designated velocity;
Stopping arm rotation by allowing it to coast to a determined or indeterminate position;
Stopping arm rotation by actively braking it;
Stopping arm rotation by actively causing it to return to a determined position; and
Storing parameters such as desired start/stop position, direction, velocity, power, time duration, angular distance, notification conditions, and stop type.

As a non-limiting example, the notifications that the Arm Rotation Subsystem may provide can include:
Signaling when the arm is stopped in normal operation;
Signaling when the arm stopped because of an error condition;
Signaling the current rotational angle of arm;
Signaling when a stable or designated arm velocity is reached;
Signaling when a stable or designated velocity is reached, and an angular point passed by the arm;
Signaling when a stable or designated velocity is reached, and a duration has passed; and
Signaling when a stable or designated velocity is reached, an angular point passed, and a duration after passing that point has passed.

The above functions and notifications might be combined into a single operation having multiple parameters that could, as a non-limiting example, enable the following:
Begin arm rotation in a clockwise direction with a target velocity of 30 rpm;
Provide notification when a 30-rpm velocity reached, and arm angle passes point 30 degrees past start position;
Continue to rotate for 720 degrees; and
Stop arm at position of 10 degrees.

The Height Subsystem 254 may be adapted for controlling the elevation of the image capture device 140. In some exemplary embodiments, the Height Subsystem can control the positioning of carriage 132 via motor 136 and limit sensors 138. Camera height can be controlled by attaching a slide and camera mount to the vertical portion of the arm in order to create a camera carriage. In one exemplary embodiment, the camera carriage may be attached to a belt or chain that is driven by a stepper motor. In another exemplary embodiment, the camera carriage may be driven by a screw type actuator using a rotary motor. Another exemplary embodiment can use a linear actuator to position the camera carriage. In all instances, the rotary or linear motors can be of brushed, brushless or stepper types having internal or external encoders and controllers appropriate for the motor type. Upper and lower limits of the camera carriage travel can be established by mechanical limit switches, as well as optical, hall-effect or ultrasonic sensors.

As a non-limiting example, the functions that the Height Subsystem may provide can include:
Initializing the carriage position and determine its position relative to the arm;
Moving the carriage to a designated position on the arm;
Saving a carriage position as a start or stop position;
Moving the carriage in a specific direction;
Moving the carriage at a specific velocity;
Moving the carriage at a specific power level;
Moving the carriage for a specific duration;
Moving the carriage for a specific distance;
Accelerating or decelerating the carriage in a controlled or uncontrolled manner;
Stopping the carriage by allowing it to coast to a determined or indeterminate position;
Stopping the carriage by actively braking it;
Stopping the carriage by actively causing it to return to a determined position; and
Storing parameters such as desired start/stop position, direction, velocity, power, time duration, distance, notification conditions, and stop type.

As a non-limiting example, the notifications that the Height Subsystem may provide can include:
Signaling when the carriage is stopped in normal operation;
Signaling when the carriage is stopped because an upper or lower limit is reached;
Signaling when the carriage stopped because of an error condition;
Signaling the current position of the carriage;
Signaling when a stable or designated velocity is reached;
Signaling when a stable or designated velocity is reached and a point on arm passed by the carriage;
Signaling when a stable or designated velocity is reached, and a duration has passed; and
Signaling when a stable or designated velocity is reached, a point on arm passed, and a duration after passing that point has passed.

The above functions and notifications may be combined into a single operation having multiple parameters that could, as a non-limiting example, enable the following:
Begin carriage descent with a target velocity of 8 inches per second;
Provide notification when an 8 inch per second velocity reached and carriage passes a point 30 inches below start position; and
Stop carriage at position of 40 inches below start position.

The Tilt Subsystem 256 may be adapted for controlling the vertical tilt angle of the image capture device 140. In some exemplary embodiments, the Tilt Subsystem can control the positioning of mount 142 via a motor associated therewith. Control of vertical camera tilt angle can be achieved by attaching motorized mounts between the camera and camera carriage. Such mounts can include external control inputs and reporting functions.

As a non-limiting example, the functions that the Tilt Subsystem may provide can include:
Initializing the tilt position of the camera support and determining its position relative to the arm;
Saving a tilt angle as a start or stop position;
Tilting the camera support to a designated angle;
Tilting the camera support in a specific direction;
Tilting the camera support at a specific velocity;
Tilting the camera support at a specific power level;
Tilting the camera support for a specific duration;
Tilting the camera support to a specific angle;
Accelerating or decelerating movement of the tilt support in a controlled or uncontrolled manner;
Stopping movement of the tilt support;
Stopping movement of the tilt support at a specific angle; and
Storing parameters such as desired start/stop angle, direction, velocity, power, time duration, distance, notification conditions, and stop type.

As a non-limiting example, the notifications that the Tilt Subsystem may provide can include:
Signaling when the tilt of the camera support is stopped in normal operation;
Signaling when the tilt of the camera support is stopped because an upper or lower limit is reached;
Signaling when the tilt of the camera is support stopped because of an error condition; and
Signaling the current angle of the camera support.

The Camera Control Subsystem 258 can control the functionality of the image capture device 140. The Camera Control Subsystem may communicatively couple to an image capture device via known wired or wireless interfaces. Control of video record start/stop, shutter operation, focus and zoom can be achieved by using cameras that provide such external control functionality and provide interfaces suitable for external electronic control or by using external solutions having such interfaces.

As a non-limiting example, the functions that the Camera Subsystem may provide can include:
Activating the camera shutter or enabling/disabling recording;
Enabling recording for a specific duration;
Saving focus and/or zoom settings as start or stop setting;
Focusing and/or zooming camera to a designated setting;
Focusing and/or zooming camera at a designated rate;
Changing the focus and/or zoom of camera at a designated rate until reaching a designated setting;
Accelerating or decelerating changes to focus/zoom following a specific curve;
Stopping changes to focus and/or zoom; and
Storing parameters such as desired start/stop settings, velocity, notification conditions.

As a non-limiting example, the notifications that the Camera Subsystem may provide can include:
Signaling when recording is enabled or completed;
Signaling when a recording error is encountered;
Signaling when focus and/or zoom is stopped in normal operation;
Signaling when focus and/or zoom stopped because an upper or lower limit is reached;
Signaling when focus and/or zoom is stopped because of an error condition;
Signaling the current recording state of camera;
Signaling the current setting of focus and/or zoom;
Signaling that photos or videos have been successfully locally stored;
Signaling to manage local storage of photos or videos;
Signaling to enable transfer of stored photos and videos;
Signaling to enable real-time transfer of photos or video content with or without local storage; and
Signaling to indicate and control other imaging device functions.

The Triggering/Notification Subsystem 260 can include triggering interfaces that allow signals from the components of mount 100 or external signals to initiate various system functions may be supplied by known wireless or wired interfaces. For example, a user-operable button may be provided as a triggering interface. As another example, a sensor such as an accelerometer may detect physical motion of the arm or image capture device. Such a sensor may be provided externally or as an integral component of another subsystem, such as the Camera Control Subsystem. As yet another example, an image processing function within, or external to, the image capture device could detect movement or human gestures and provide an associated trigger. Similarly, The Triggering/Notification Subsystem 260 can include notification interfaces that report or signal a current state of the system or one or more of the subsystems on a periodic basis or upon a change in state may also be supplied by known wired or wireless interfaces. For example, a notification interface may provide a visual or auditory signal to report on a state of the system, in response to a triggering input, or when certain conditions are satisfied. Such signals may include, as a non-limiting example, displaying messages, launching confetti, flashing lights, playing sounds, playing messages, and so forth.

The User Interface Subsystem 262 can include one or more user interfaces for configuration and, in some embodiments, for live control of the system can be provided by devices such as:
Smartphones, tablets, laptops or other devices offering similar capabilities;
Housings containing an embedded controller, appropriate display and input components; and
Housings containing basic electronics and/or mechanical components (such as a pushbutton switch) that are designed to simply display information from and/or transmit a signal to a controller running user interface logic.

User interfaces may connect directly with a Supervisory or Subsystem Controllers in a wired or wireless manner.

The Supervisory System 264 can include one or more Controllers. Control circuits and programming that allow subsystems to be configured, coordinated, operated and monitored in an integrated manner. Supervisory Subsystems may be embedded into one or more subsystems or contained in separate housings. Supervisory Controllers may receive signals and notifications from the various subsystems and issue control commands to the various subsystems. Supervisory control may be implemented in a wired or wireless manner and may be embedded within applications that incorporate a rotational camera as part of a larger system. Supervisory Controllers may retain configuration parameters locally or direct other Subsystem Controllers to do so.

Parameters may also be combined into “sets” that allow a specific configuration to be saved and recalled within the Supervisory or Subsystem Controllers.

In some exemplary embodiments, control system 250 may include Subsystem Controllers. Circuitry and programming specific to control of a particular subsystem may be embedded within the mechanical components required for the subsystem or contained in separate enclosures attached to the arms or chassis. In some exemplary embodiments, subsystem controllers may be combined into a single set of circuitry and programming (tilt and height, for example).

Subsystem Controllers may communicate between themselves and/or with upstream Supervisory Controller(s) in a wired or wireless manner. Subsystem Controllers may provide user interfaces allowing configuration and operation. They may also save settings allowing them to recall operational parameters or to be addressed/identified as part of a network.

In exemplary embodiments, control of the Arm Rotation Subsystem 252 can be an essential component.

Battery Placement: In some embodiments, it may be desirable to use one or more external batteries to provide power to one or more subsystems attached to the arm. In such cases, the battery or batteries may be mounted in a position that is more than 90 degrees axially from the camera arm. This location could be for reasons of space or to provide a counterweight function.

Example 1: In one exemplary embodiment, subsystems may be implemented as follows:

Arm Rotational Subsystem: This subsystem may include a microcontroller which runs a closed loop algorithm allowing the arm speed and position to be controlled and monitored. A brushed DC motor may be attached to the arm through a mechanical system causing the arm to rotate. A motor controller circuit can supply PWM-regulated voltage to the motor based upon low-voltage signals supplied by the microcontroller. An external rotational encoder can monitor the rotational speed of the hub to which the camera arm is attached and can transmit a series of pulses using quadrature encoding to the microcontroller. During each arm rotation, a magnet attached to the arm can activate a Hall-effect sensor that is connected as an input to the microcontroller, allowing it to identify the physical position of the arm relative to the chassis; this data can be used by the microcontroller to calibrate the rotational encoder and to place the arm at a known angle relative to the chassis.

A wireless communication device may be contained in the same housing as the microcontroller, allowing the microcontroller to receive commands from an upstream supervisory controller and to transmit status back to it. The wireless communication device may use any desired protocol, for example Bluetooth, Bluetooth LE, Wi-Fi, and so forth.

Camera, User Interface and Supervisory Subsystems: In this exemplary embodiment, the Camera, User Interface and Supervisory Systems may be contained in an electronic device that is coupled to the arm. The supervisory control application can communicate directly with the User Interface and Camera Subsystems while a wireless communication link, which may utilize any desired wireless communication protocol, may be used for communication with the Arm Rotation Subsystem. The supervisory application can allow the user to define and save parameters that dictate how the system will perform in an integrated manner. The supervisory application can store user preferences and/or a sequence of commands that can invoke one or more of the above described functions of the various subsystems, such that a desired sequence is performed upon a user input, an external input, a user-programmed parameter, and/or a signal from one or more of the various subsystems. As a non-limiting example, the supervisory application can cause the following sequence to be performed when a user presses a “Start” button that is incorporated as part of the user interface:
The Supervisory system causes the Arm Rotational Subsystem to accelerate the arm to 30 RPM in a clockwise direction;
After reaching 30 RPM and passing a rotational angle of 270 degrees, the Arm Rotational subsystem sends a notification to the Supervisory System indicating that this point has been reached;
Upon receipt of notification, the Supervisory System causes the Camera Subsystem to enable recording for 3 seconds; and
After a duration of 3.2 seconds, the Supervisory System causes the Arm Rotation Subsystem to decelerate to a stopped position at an angle of 30 degrees.

Example 2: In another exemplary embodiment, all the subsystems in example 1 may be present and an additional Trigger/Reporting Subsystem may be added to the enclosure containing the Arm Rotational Subsystem. The Trigger/Reporting Subsystem can implement a control circuit that initiates a visual or auditory sequence upon a triggering action. As a non-limiting example, the Trigger/Reporting Subsystem can include a DMX512 master control circuit that can drive two devices that launch confetti, and may further be connected to a hardwired pushbutton switch via, for example, 20 feet of cable, so as to enable the following exemplary operation:
When the pushbutton switch is pressed, the Trigger/Reporting Subsystem notifies the Supervisory System of this occurrence;
The Supervisory system causes the Arm Rotational Subsystem to accelerate the arm to 30 RPM in a clockwise direction;
After reaching 30 RPM and passing a rotational angle of 270 degrees, the Arm Rotational Subsystem sends a notification to the Supervisory system indicating that this point has been reached;
Upon receipt of notification, the Supervisory System commands the Trigger/Notification Subsystem to deliver DMX parameters to the confetti launchers, causing them to operate for a period of 2 seconds;
After a further delay of 1.5 seconds, the Supervisory System commands the Camera Subsystem to enable recording for 3 seconds; and
After a further delay of 3.2 seconds, the Supervisory System commands the Arm Rotation Subsystem to decelerate to a stopped position at an angle of 30 degrees.

Example 3: In yet another exemplary embodiment, the Arm Rotation and Trigger/Notification Subsystems in example 2 may be present but the Camera Subsystem may be implemented as a separate commercial image capture device, for example a camera, that includes an external interface for controlling recording, focus and zoom. The primary User Interface and Supervisory Application may be located on a computer or mobile device that communicates via Wi-Fi or another protocol with the image capture device. Tilt and Height Subsystems have been added to the arm and may physically support the camera. The Tilt and Height Subsystems, as well as the Arm Rotation and Trigger/Notification Subsystems, may communicate with the Supervisory Application on the computer or mobile device via a wireless communication link. The wireless communication link may use any desired protocol, for example Bluetooth, Bluetooth LE, Wi-Fi, and so forth. An application utilizing the wireless protocol and running on a computing or mobile device can replace the physical switch previously connected to the Trigger/Reporting Subsystem. The Camera, Height and Tilt Subsystems may be powered by one or more batteries, for example a common battery that is placed on an arm 180 degrees opposite the one carrying these subsystems. Such a placement of the battery serves to counterbalance the Camera, Height, and Tilt Subsystems. As a non-limiting example, the following sequence may be performed when a user presses the “Start” button on a computing or mobile device that is communicatively coupled to the subsystems:
A wireless message is sent from the phone application to the Supervisory System running on a laptop;
Upon receipt of notification, the Supervisory System commands the Tilt, Height, Focus, Zoom and Arm Rotation Subsystems to move to their predefined starting positions;
When all subsystems report that they have reached their starting positions, the Supervisory System causes the Arm Rotational Subsystem to accelerate the arm to 30 RPM in a clockwise direction;
After reaching 30 RPM and passing a rotational angle of 270 degrees, the Arm Rotational Subsystem sends a notification to the Supervisory System indicating that this point has been reached;
Upon receipt of the notification, the Supervisory System commands the Trigger/Notification Subsystem to deliver DMX parameters to the confetti launchers, causing them to operate for a period of 2 seconds;
After a further delay of 1.5 seconds, the Supervisory System commands the Height Subsystem to begin descending at a rate of 9 inches per second and the Tilt Subsystem to begin rotating upwards at a rate of 10 degrees per second;
After a further delay of 0.2 commands the Supervisory System commands the Camera Subsystem to begin recording for a duration of 3 seconds; and
After a further delay of 3.2 seconds, the Supervisory System commands the Tilt, Height, Focus/Zoom, and Arm Rotation Subsystems to return to their starting positions and then stop.

Example 4: In yet another exemplary embodiment, the Arm Rotation and Trigger/Notification Subsystems in example 1 may be present but the Camera Subsystem may be implemented as a separate image capture device such as a smartphone that includes an external interface for controlling recording, an imaging processing unit for detecting human gestures, and an accelerometer that can detect arm movement. The primary User Interface and Supervisory Application may be located on a computing or mobile device that communicates via Wi-Fi or another protocol with the image capture device. As a non-limiting example, the following sequence may be performed when a user, standing on the platform or within the imaging area and within the view of the image capture device, raises both arms causing the gesture-detection process to provide a signal to the Supervisory Subsystem that such a gesture has occurred:
A wireless notification indicating that the gesture has occurred is sent from the Notification Subsystem running on the mobile device to the Supervisory System running on a local Supervisory Controller;
Upon receipt of the notification, the Supervisory System commands the Arm Rotational Subsystem to accelerate the arm to 30 RPM in a clockwise direction;
As the arm accelerates, the internal accelerometer of the smartphone detects the motion and causes the Notification Subsystem running on the smartphone to send a notification to the Camera Subsystem and to the Supervisory Subsystem indicting that rotation has commenced;
Upon receipt of notification, the Camera Subsystem enables recording for 3 seconds; and
After a duration of 3.2 seconds, the Supervisory System causes the Arm Rotation Subsystem to decelerate to a stopped position at an angle of 30 degrees.

It should be appreciated that while several examples of the configuration of the orbiting camera mount have been described above, the orbiting camera mount can be configured in any manner and with any desired components that enable the orbiting camera mount to function as described herein. Furthermore, the various functionalities, operations, and sequences of the subsystems of the camera mount may be configured in any order, length, or combination of parameters, and are not solely limited to the provided examples.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. An apparatus for operating an imaging device, comprising:
a platform assembly supporting the apparatus on a surface and extending in a first plane;
a first arm rotatable about an axis of rotation orthogonal to the first plane, the axis of rotation being disposed at the platform assembly;
a second arm coupled to the first arm and extending in a second plane;
a carriage slidably coupled to the second arm, the carriage including a mount couplable to the imaging device, the mount being tiltable in the second plane; and
at least one control system configured to control one or more of a rotation of the first arm, a sliding of the carriage, and a tilting of the mount.

2. The apparatus of claim 1, the platform assembly further comprising a first plate supported on the surface and a second plate coupled to the first plate by a shaft disposed therebetween, wherein the first arm is rotatably coupled to the shaft.

3. The apparatus of claim 1, wherein:
the second arm is pivotably coupled to the first arm proximate a first end of the first arm; and
a counterweight is disposed proximate a second end of the first arm that is opposite the first end.

4. The apparatus of claim 1, further comprising:
a first sheave disposed proximate a first end of the second arm;
a second sheave disposed proximate a second end of the second arm; and
a belt movably mounted on the first and second sheave and coupled to the mount.

5. The apparatus of claim 1, wherein the at least one control system is remotely controllable.

6. The apparatus of claim 1, wherein the at least one control system comprises one or more of:
an arm rotation subsystem configured to control the rotation of the first arm;
a height position subsystem configured to control the sliding of the carriage; and
a tilt subsystem configured to control the tilting of the mount.

7. The apparatus of claim 6, further comprising a camera control subsystem configured to control an operation of the image capture device.

8. The apparatus of claim 7, wherein:
the at least one control system is programmable such that one or more subsystem of the subsystems performs at least one operation based on one or more of a user-programmed parameter, an external input, and an operational status of one or more subsystem of the subsystems.

9. A system for controlling an imaging device and having a plurality of subsystems, comprising:
an arm rotation subsystem configured to electronically control an orbiting of the imaging device about an axis of rotation;
a height position subsystem configured to control a height of the imaging device in a plane containing the imaging device and the axis of rotation; and
a tilt position subsystem configured to control a tilting of the imaging device about a tilting axis orthogonal to the plane containing the imaging device and the axis of rotation;
wherein, in operation, the imaging device is maintained in orientation so as to capture a portion of the axis of rotation, irrespective of the orbiting, height, and tilt of the imaging device.

10. The system of claim 9, further comprising a camera control subsystem configured to control an operation of the image capture device.

11. The system of claim 10, wherein each subsystem of the plurality of subsystems is remotely controllable.

12. The system of claim 9, wherein:
the system is configured to receive signals from at least one subsystem of the plurality of subsystems so as to receive subsystem status information; and
the system is configured to send signals to at least one subsystem of the plurality of subsystems so as to control subsystem operation.

13. The system of claim 9, further comprising a trigger/notification subsystem configured to initiate a function of one or more of the other subsystems in response to an external signal and to provide a signal in response to a condition of one or more of the other subsystems and/or in response to an external condition.

14. The system of claim 9, wherein each subsystem of the plurality of subsystems is configured to provide a signal with respect to one or more operational statuses of said subsystem.

15. The system of claim 9, further comprising a supervisory system configured to control and coordinate each subsystem of the plurality of subsystems and to receive signals from each subsystem of the plurality of subsystems.

16. The system of claim 9, wherein:
the plurality of subsystems is programmable such that one or more subsystem of the plurality of the subsystems performs at least one operation based on one or more of a user-programmed parameter, an external input, and an operational status of one or more subsystem of the plurality of subsystems.

17. The system of claim 9, wherein:
the arm rotation subsystem comprises an orbital arm orbiting the axis of rotation;
the height position subsystem comprises a carriage slidably coupled to the orbital arm; and
the tilt position subsystem comprises a mount pivotably coupled to the carriage.

18. The system of claim 17, further comprising:
a platform assembly; and
a rotating arm rotatably coupled to the platform assembly and having a first end coupled to an end of the orbital arm.

19. The system of claim 18, further comprising a counterweight coupled to a second end of the rotating arm.

20. An apparatus for operating an imaging device, comprising:
an orbiting arm orbiting about an area where an object to be imaged is placeable;
a carriage disposed on the orbiting arm and movable at least in an elevation direction;
a mount coupled to the carriage and couplable to the imaging device, the mount being tiltable in the plane of the orbiting arm; and
at least one control system configured to control a movement of one or more of the orbiting arm, the carriage, and the mount;
wherein, in operation, the imaging device is maintained in orientation so as to capture the object to be imaged, irrespective of an orbital position, an elevation, and a tilt of the imaging device.
